(19) United States
(12) Patent Application Publication
(10) Pub. No.: US 2023/0390029 A1
(43) Pub. Date: Dec. 7, 2023

(54) ABUTMENT COUPLED TO UPPER PART OF DENTAL IMPLANT FIXTURE

(71) Applicant: ONEDAY BIOTECH CO.,LTD, Daegu (KR)

(72) Inventors: Jin Hwan KIM, Seoul (KR); Jae Hyun SONG, Seoul (KR)

(21) Appl. No.: 18/327,237

(22) Filed: Jun. 1, 2023

(30) Foreign Application Priority Data
Jun. 7, 2022 (KR) 10-2022-0068983

(51) Int. Cl. A61C 8/00

(52) U.S. Cl. CPC A61C 8/0092; A61C 8/0068; A61C 8/0001; A61C 8/0069

(57) ABSTRACT

An abutment coupled to an upper part of a dental implant fixture includes a coupler coupled to a polygonal groove or a polygonal protrusion of the fixture; and a body mounted with a crown which is an artificial tooth and has a shape to be connected to a mount driver used for coupling to the fixture and serves as a scan body for digital impression.

### CROSS-REFERENCE TO RELATED APPLICATION

This application claims the benefit under 35 USC 119(a) of Korean Patent Applications No. 10-2022-0068983 filed on Jun. 7, 2022, in the Korean Intellectual Property Office, the entire disclosures of which are incorporated herein by reference for all purposes.

### TECHNICAL FIELD

The present disclosure relates to an abutment coupled to an upper part of a dental implant fixture.

### BACKGROUND

A dental implant (hereinafter, briefly referred to as an “implant”) is an artificial root that is anchored in the gum and jawbone of a patient to support a crown which restores the structure and function of a tooth missing or pulled out. Therefore, the implant is also called an artificial tooth or a third tooth.

FIG. 1 is a configuration diagram of a general implant. Referring to FIG. 1, an implant 10 includes a fixture 11, an abutment 12 and a crown 13. The fixture 11 is installed in the alveolar bone and serves as a tooth root, and the abutment 12 is coupled to the fixture 11 and transfer a force applied to the crown 13 to the fixture. Further, the crown 13 is coupled to the abutment 12 and serves as a tooth.

Implant surgery is performed by cutting open the gum in the mouth of a patient to check an implant site, and drilling the jawbone to implant the fixture 11 into the jawbone. When a predetermined time elapses after the fixture 11 is implanted, the crown 13 is inserted into the fixture 11 by using the abutment 12 to implant the implant 10 in the patient's mouth.

In order to precisely implant the implant 10 in the patient's mouth, a process of taking impressions of the patient's mouth needs to be performed accurately and precisely. Through this process, the customized-abutment 12 adapted to the patient can be fabricated. Then, the crown 13 is inserted into the customized-abutment 12.

Conventionally, a process of taking impressions is performed using an impression coping. Specifically, a mount is affixed to an inner groove of the fixture 11 previously implanted in the patient's mouth and then fixed to the fixture 11 by using a mount driver. Then, the fixture 11 is implanted in the patient's mouth.

Then, the mount is removed from the fixture 11 and the impression coping is affixed to the fixture 11 to perform the process of taking impressions. When the process of taking impressions is completed, the impression coping is removed, and a healing abutment is affixed to the fixture 11 if necessary.

Thereafter, the crown 13 is fabricated using an impression product. During an implant operation, the abutment 12 is affixed to the fixture 11 and the crown 13 is inserted into the abutment 12.

As described above, in a conventional case, a process of affixing each of the mount, the impression coping and the healing abutment to the fixture 11, a processing of separating each of them from the fixture 11, and a process of affixing the abutment 12 to the fixture 11 need to be performed. In the meantime, the fixture 11 requiring delicacy can be damaged.

### PRIOR ART DOCUMENT

### Patent Document

Patent Document 1: Korean Patent No. 10-1026775 (registered on Mar. 28, 2011)

Patent Document 2: Korean Patent No. 10-1091587 (registered on Dec. 2, 2011)

### SUMMARY

In view of the foregoing, the present disclosure provides an abutment that further facilitates an implant operation.

Specifically, the present disclosure provides an abutment with which it is possible to consolidate all of a process of affixing a mount to a fixture, a process of affixing an impression coping to the fixture, and a process of affixing an abutment to the fixture during an implant operation into a single process.

The problems to be solved by the present disclosure are not limited to the above-described problems. There may be other problems to be solved by the present disclosure.

According to an aspect of the present disclosure, an abutment coupled to an upper part of a dental implant fixture includes a coupler coupled to a polygonal groove or a polygonal protrusion of the fixture; and a body mounted with a crown which is an artificial tooth and has a shape to be connected to a mount driver used for coupling to the fixture and serves as a scan body for digital impression.

The above-described aspects are provided by way of illustration only and should not be construed as liming the present disclosure. Besides the above-described embodiments, there may be additional embodiments described in the accompanying drawings and the detailed description.

According to the present disclosure, an implant operation can be performed more simply. Specifically, it is possible to provide an abutment with which it is possible to consolidate all of a process of affixing a mount to a fixture, a process of affixing an impression coping to the fixture, and a process of affixing an abutment to the fixture during an implant operation into a single process.

### BRIEF DESCRIPTION OF THE DRAWINGS

In the detailed description that follows, embodiments are described as illustrations only since various changes and modifications will become apparent to a person with ordinary skill in the art from the following detailed description. The use of the same reference numbers in different figures indicates similar or identical items.

FIG. 1 is a configuration diagram of a general implant.

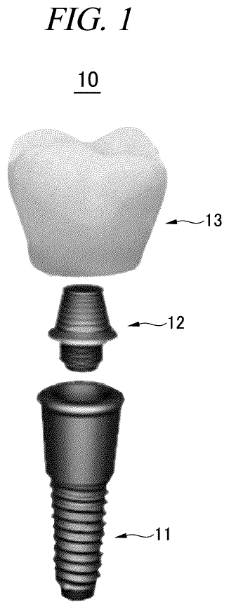

FIG. 2 is a front view of an abutment.

FIG. 3A shows a side view of the abutment.

FIG. 3B shows a side view of the abutment.

FIG. 3C shows a plan view of the abutment.

FIG. 4 is a perspective view of the abutment.

FIG. 5 is a perspective view of the abutment.

FIG. 6 is a diagram for explaining an example of a multi-implant operation.

### DETAILED DESCRIPTION

Hereinafter, embodiments of the present disclosure will be described in detail with reference to the accompanying drawings so that the present disclosure may be readily implemented by a person with ordinary skill in the art. However, it is to be noted that the present disclosure is not limited to the embodiments but can be embodied in various other ways. In drawings, parts irrelevant to the description are omitted for the simplicity of explanation, and like reference numerals denote like parts through the whole document.

Through the whole document, the term “comprises or includes” and/or “comprising or including” used in the document means that one or more other components, steps, operation and/or existence or addition of elements are not excluded in addition to the described components, steps, operation and/or elements unless context dictates otherwise. Further, through the whole document, the term “connected to” or “coupled to” that is used to designate a connection or coupling of one element to another element includes both a case that an element is “directly connected or coupled to” another element and a case that an element is “electronically connected or coupled to” another element via still another element. Further, through the whole document, the term “on” that is used to designate a position of one element with respect to another element includes both a case that the one element is adjacent to the other element and a case that any other element exists between these two elements.

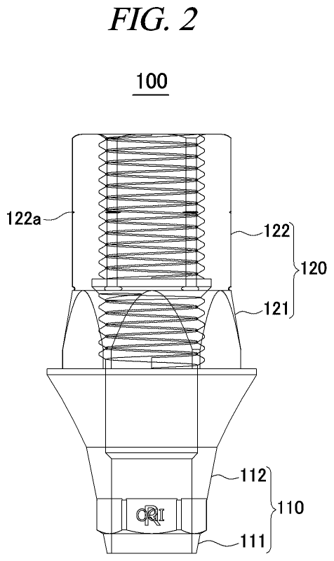

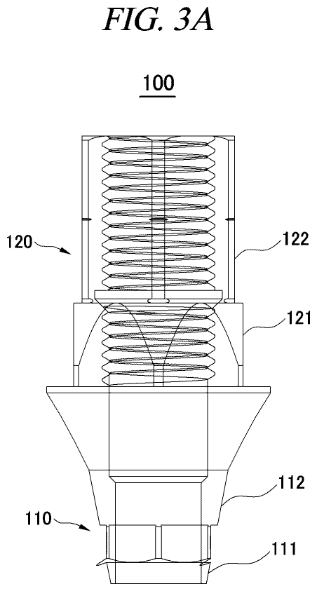

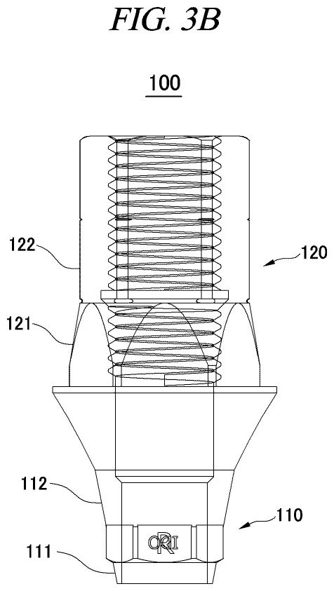

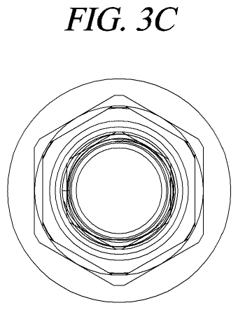

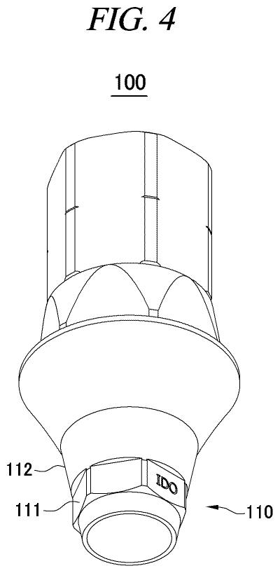

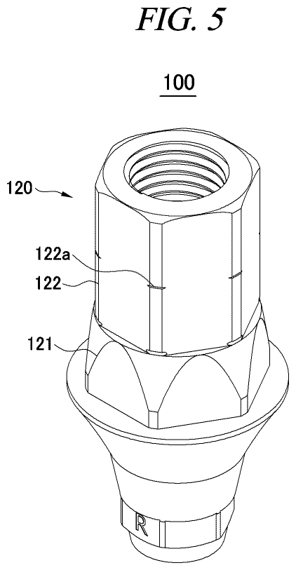

Hereinafter, an exemplary embodiment of the present disclosure will be described in detail with reference to the accompanying configuration views or process flowcharts. FIG. 2 is a front view of an abutment, and FIGS. 3A-3C show side views and a plan view of the abutment. Also, FIG. 4 and FIG. 5 are perspective views of the abutment.

Referring to FIG. 2 and FIG. 3A-3C, an abutment 100 coupled to an upper part of a dental implant fixture may include a coupler 110 and a body 120. FIG. 3A is a rear view of the abutment 100, FIG. 3B is a side view of the abutment 100, and FIG. 3C is a plan view of the abutment 100.

However, the abutment 100 illustrated in FIG. 2 and FIGS. 3A-3C is merely an embodiment of the present disclosure, and various modifications based on the components illustrated in FIG. 2 and FIGS. 3A-3C are possible.

Referring to FIG. 2 and FIGS. 3A-3C, the coupler 110 is coupled to a polygonal groove or a polygonal protrusion of the fixture. For example, the coupler 110 may have a shape with a diameter corresponding to the internal groove of the fixture.

Referring to FIG. 4, the coupler 110 includes a lower coupler 111 and an upper coupler 112. The lower coupler 111 has a tapered shape with a diameter gradually decreasing downwards.

Further, the upper coupler 112 is formed on the lower coupler 111 and has a tapered shape with a steeper inclination than the lower coupler 111.

An upper surface of the upper coupler 112 has a greater diameter than a lower surface of a lower body 121. For example, the upper coupler 112 may have a circular shape, and may be designed to be greater in diameter than the lower surface of the lower body 121.

The body 120 is mounted with a crown which is an artificial tooth and has a shape to be connected to a mount driver used for coupling to the fixture and serves as a scan body for digital impression. Alternatively, the body 120 may serve as an impression coping for a conventional process for taking impressions.

For example, the body 120 may serve as a scan body which can easily identify location information of the fixture during scanning by an intraoral scanner.

Specifically, the scan body needs to have a polygonal cross-section for data matching while the scan body is scanned. As described below, the body 120 may be designed to have a hexagonal shape in order for the abutment 100 according to the present disclosure to serve as a scan body.

Also, the body 120 according to the present disclosure may have a rough surface through a sand blasting process and thus can more efficiently serve as a scan body.

According to the present disclosure, the abutment 100 affixed to the fixture is scanned with the scanner, and, thus, it is possible to check the oral structure of the patient and the structure and shape of the fixture implanted in the patient's mouth.

Also, the body 120 may serve as a mount while the fixture is implanted. In general, the mount may be affixed to an inner groove of the fixture, and while the affixed mount is gripped and turned with the mount driver, the fixture is inserted into the gum of the patient.

Here, the abutment 100 according to the present disclosure is affixed to the fixture, and while the affixed abutment 100 is gripped and turned with a motor driver, the fixture can be implanted into the patient's gum.

To this end, the body 120 may have a hexagonal shape to be gripped by the motor driver. As shown in FIG. 5, the body 120 may have a hexagonal structure.

Since the body 120 is designed to have a hexagonal shape, it is possible to suppress a turn of the abutment 100 in the patient's mouth.

According to the present disclosure, the abutment 100 can serve as a mount. Thus, a separate mount is not needed.

The body 120 includes the lower body 121 and an upper body 122. The lower body 121 has a trapezoidal shape with a diameter gradually increasing downwards, and the upper body 122 is formed on the lower body 121 and has a polyprism shape.

Since the lower body 121 has a trapezoidal shape, it is possible to easily perform a multi-implant operation.

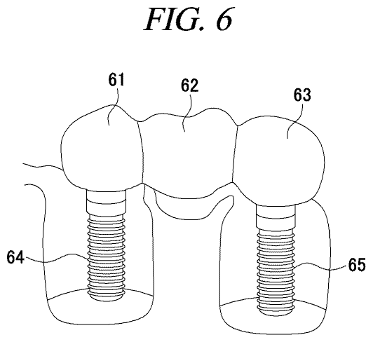

FIG. 6 is a diagram for explaining an example of the multi-implant operation.

Referring to FIG. 6, the multi-implant operation is performed to simultaneously insert a plurality of crowns 61, 62 and 63 into a plurality of adjoining abutments. In this case, if adjoining fixtures are implanted at different angles from each other, it is difficult to insert the plurality of crowns 61, 62 and 63, or the crowns 61, 62 and 63 may interfere with each other.

To solve this problem, in the abutment 100 according to the present disclosure, the lower body 121 has a trapezoidal shape. Therefore, even if the fixtures are implanted at different angles from each other, the plurality of crowns 61, 62 and 63 can be easily inserted during the multi-implant operation. Also, it is possible to reduce interference among the crowns 61, 62 and 63.

Referring back to FIG. 2 and FIGS. 3A-3C, the abutment 100 may include a plurality of grooves 122a formed at a specific height of the upper body 122 along the circumference of the upper body 122.

In general, the length of a tooth may vary in different patients, and, thus, the abutment 100 needs to be adapted to each individual patient.

The abutment 100 according to the present disclosure includes the plurality of grooves 122a formed along the circumference of the upper body 122, and, thus, the upper body 122 can be easily cut. That is, the length of the abutment 100 can be easily adjusted to fit the length of a tooth of each patient based on the plurality of grooves 122a. The above description of the present disclosure is provided for the purpose of illustration, and it would be understood by a person with ordinary skill in the art that various changes and modifications may be made without changing technical conception and essential features of the present disclosure. Thus, it is clear that the above-described embodiments are illustrative in all aspects and do not limit the present disclosure. For example, each component described to be of a single type can be implemented in a distributed manner. Likewise, components described to be distributed can be implemented in a combined manner.

The scope of the present disclosure is defined by the following claims rather than by the detailed description of the embodiment. It shall be understood that all modifications and embodiments conceived from the meaning and scope of the claims and their equivalents are included in the scope of the present disclosure.

We claim:

1. An abutment coupled to an upper part of a dental implant fixture, comprising:
a coupler coupled to a polygonal groove or a polygonal protrusion of the fixture; and
a body mounted with a crown which is an artificial tooth and has a shape to be connected to a mount driver used for coupling to the fixture and serves as a scan body for digital impression.

2. The abutment of claim 1,
wherein the body has a hexagonal cross-section.

3. The abutment of claim 1,
wherein the body includes:
a lower body having a trapezoidal shape with a diameter gradually increasing downwards; and
an upper body formed on the lower body and having a polyprism shape.

4. The abutment of claim 3, further comprising:
a plurality of grooves formed at a specific height of the upper body along the circumference of the upper body.

5. The abutment of claim 3,
wherein the coupler includes:
a lower coupler having a tapered shape with a diameter gradually decreasing downwards; and
an upper coupler formed on the lower coupler and having a tapered shape with a steeper inclination than the lower coupler.

6. The abutment of claim 5,
wherein an upper surface of the upper coupler has a greater diameter than a lower surface of the lower body.
